(19) United States
(12) Patent Application Publication
(10) Pub. No.: US 2011/0285096 A1
(43) Pub. Date: Nov. 24, 2011

(54) SEALING JOINT WITH INTEGRATED MATING SURFACE

(75) Inventor: Serge Bunel, Le Havre (FR)

(73) Assignee: AIRCELLE, Gonfreville L'Orcher (FR)

(21) Appl. No.: 12/674,171

(22) PCT Filed: Aug. 8, 2008
(86) PCT No.: PCT/FR2008/001180

§ 371 Date: Feb. 19, 2010

(30) Foreign Application Priority Data
Aug. 20, 2007 (FR) 0705898

(51) Int. Cl. F16J 15/02

(52) U.S. Cl. 277/634

(57) ABSTRACT

The invention relates to a sealing joint (101) designed to be arranged between a first duct (100) and a second duct which are susceptible to relative axial and/or radial movements, yet belonging to the same fluid distribution circuit, said joint comprising a flexible central part (103) with a generally cylindrical shape matching the form of the first and second ducts and made from material resistant to said fluid, having a mounting surface (102) for fixing to the first duct on one side and a mating surface (104) on the other side for making contact with the second duct such as to provide a flexible sealing connection between the first and second duct, characterised in that the mating surface has a peripheral reinforcement (110) extending radially at least partly above the central part.

### TECHNICAL FIELD

The invention relates to a seal intended to be fitted between two duct elements liable to undergo relative movement in a nacelle for a turbojet engine.

### BACKGROUND

An aircraft is propelled by a number of turbojet engines each housed in a nacelle; each nacelle also houses a collection of ancillary devices associated with the operation thereof and performing various functions when the turbojet engine is operating or stationary.

A nacelle generally has a tubular structure comprising an air intake forward of a turbojet engine, a middle section intended to surround a fan of the turbojet engine, a rear section that may house thrust-reversal means and is intended to surround the combustion chamber of the turbojet engine, and a jet pipe, the outlet of which is situated downstream of the turbojet engine.

Modern nacelles are often intended to house a bypass turbojet engine capable, via the blades of the rotating fan, of generating a flow of hot air (also known as the primary flow) from the turbojet engine combustion chamber.

A nacelle conventionally has an outer structure, known as the Outer Fixed Structure (OFS), which, together with a concentric inner structure, known as the Inner Fixed Structure (IFS), comprising a cowl surrounding the structure of the turbojet engine proper to the rear of the fan, defines an annular duct for flow, also known as a flow path, intended to channel a flow of cold air, known as the secondary or bypass flow, which passes around the outside of the turbojet engine. The primary and secondary flows are ejected from the turbojet engine via the rear of the nacelle.

Each airplane propulsion unit is thus formed of a nacelle and a turbojet engine, and is suspended from a fixed structure of the airplane, for example under a wing or on the fuselage, via a pylon or a strut attached to the turbojet engine or to the nacelle.

The rear section of the outer structure of the nacelle is usually formed of two cowls of substantially semicylindrical shape, one on each side of a longitudinal vertical plane of symmetry of the nacelle, and movably mounted such that they can be deployed between a working position and a maintenance position which provides access to the turbojet engine.

The two cowls are generally pivot-mounted about a longitudinal axis that forms a hinge in the top part (at the 12 o'clock position) of the reverser. The cowls are kept in a closed position by means of latches positioned along a meeting line situated in the bottom part (in the 6 o'clock position).

The same is generally true of the middle section which also has the ability to open to provide access to the fan.

It can thus be seen that an airplane propulsion unit incorporates functional subassemblies which have relative movements and between which the sealing needs to be controlled.

More specifically, it should be noted that the rear and middle sections respectively comprise subassemblies acting as casing for the nozzle and as casing for the fan, these regions of the propulsion unit playing an important part in generating and directing the flows.

These subassemblies are subjected to temperatures that cause them to expand and give rise to deformations, notably radial deformations.

Thus, whereas the gap between the fan casing and the blades of said fan needs to be controlled in order to ensure optimum fan efficiency, radial expansion of the casing carries the risk of increasing the size of this gap and therefore of reducing fan performance because more uncompressed air will be able to escape through this gap.

To prevent this disadvantage, the fan casing is equipped with a circuit for distributing cold air at its surface, this cold air generally being bled off by a scoop located in a region through which the cold flow passes (the flow path region).

This principle also applies to other parts of the nacelle, such as the jet pipe.

It will also be noted that, in operation, the subassemblies may be subjected to longitudinal deformations the effects of which also need to be obviated.

As mentioned previously, because of the discontinuities between the subassemblies, the air distribution ducts run through several subassemblies and also experience breaks in continuity where sealing has to be effected using a seal.

Because these seals are generally made either from silicone or from a braided material, they exhibit a degree of fragility to wear, to friction and to shear, and also have low crushing strength.

Now, given the large size of the components involved, the subassemblies may, during operation, experience substantial relative movement. A seal interposed between two such subassemblies therefore has to create a sealing barrier whatever the relative position of one subassembly in relation to the other. Given the compressibility of known seals and the magnitude of the movement over which sealing is to be afforded, it has been found that known seals are not dependably able to provide this sealing under all circumstances and that there is a risk that the connection between the parts of the duct will be poor and that the flow of the fluid will be impaired or even that leaks will arise.

### BRIEF SUMMARY

The disclosure addresses all or some of the abovementioned disadvantages and the invention therefore comprises a seal intended to be fitted between a first duct and a second duct which are liable to undergo axial and/or radial relative movements but which belong to one and the same fluid distribution circuit, said seal comprising a flexible central part having a substantially cylindrical overall shape tailored to the shape of the first and second ducts and made from a material that is fluidtight in respect of the fluid concerned and having, on one side, a mounting surface intended to allow the seal to be fixed to the first duct, and, on the other side, a mating surface intended to come into mating contact with the second duct in order to produce a fluidtight flexible connection between the first and second ducts, characterized in that the mating surface comprises a peripheral reinforcement running radially at least partially over the central part.

Thus, by providing a mating surface, that is to say a surface that is not fixed in a corresponding end of a duct, unlike the mounting surface, equipped with a peripheral reinforcement running radially, this reinforcement will act as a screen protecting the central part. The shear and friction forces resulting from movements that are lateral and axial will be borne by the reinforcing plate rather than by the fragile flexible material of which the central part of the seal is made.

An arrangement such as this makes it possible to minimize the area of contact between the mating surface and the second duct, the two being liable to move relative to one another.

Furthermore, when the seal is subjected to a compressive force, the central part, also known as the skirt, will naturally have a tendency to become compressed and to form rolls which could protrude beyond the overall space of the seal and come into contact with the second duct or with some other surface. This is not desirable because relative movements would then carry the risk of causing damage to the skirt, and not just the mating surface. The reinforcing plate provides containment for these potential protrusions of the central part in the event of compression.

Moreover, it will be noted that the reinforcing plate is located at the mating surface. It does not therefore impair the overall flexibility of the seal and does not influence the compression forces.

In this way, the skirt of the seal no longer comes into direct contact with the mating surface of the second duct but is protected by the reinforcing plate which has better resistance to wear.

Advantageously, mounting surface is made from a fixing ring having holes intended to accept fixing means able to collaborate with corresponding bores in the first duct.

For preference, the fluidtight central part is made of silicone.

Alternatively or in addition, the fluidtight central part is made of glass and/or ceramic fiber.

Alternatively or in addition again, the fluidtight central part is made of aramid fiber.

For preference, the fibers are woven.

Advantageously, the reinforcement is a plate made of stainless steel.

For preference, the reinforcement comprises a peripheral part built into the mass of the seal. Thus, part of the seal may be molded around part of the reinforcing surface.

Advantageously, the reinforcement has a perforated surface. This minimizes the mass of the reinforcement and therefore the additional mass of the seal according to the invention, by comparison with a seal of the prior art.

Advantageously, the reinforcement has an external peripheral edge that is flanged or locally stiffened. A feature such as this improves the overall stiffness of the reinforcement and thus makes it possible to minimize the deformation thereof, notably in the event of fire, and therefore to avoid any leaks at its mating face.

For preference, the central part comprises an external surface and an internal surface that are peripheral, delimiting a hollow interior space. Such a structure gives the seal better tolerance to compression. In general, the seal may be made up of one or more walls.

Advantageously, the reinforcement has a stiffened external peripheral part.

Of course, the seal may, with no particular preference, be fixed either to the first or to the second duct. In the application more particularly targeted here, the seal may with no particular preference be fixed either to the scoop or to the duct at the engine end.

### BRIEF DESCRIPTION OF THE DRAWINGS

For a good understanding thereof, the invention is described with reference to the attached drawing which, by way of nonlimiting example, depicts one embodiment of a seal according to this invention.

FIG. 1 is a schematic perspective view of a half-shell of a turbojet engine nacelle rear structure.

FIG. 2 is an enlarged view of the seal shown in its environment in FIG. 1.

FIG. 3 is a perspective depiction of the seal according to the invention.

FIG. 4 is a partial view of the seal of FIG. 3, in cross section.

### DETAILED DESCRIPTION

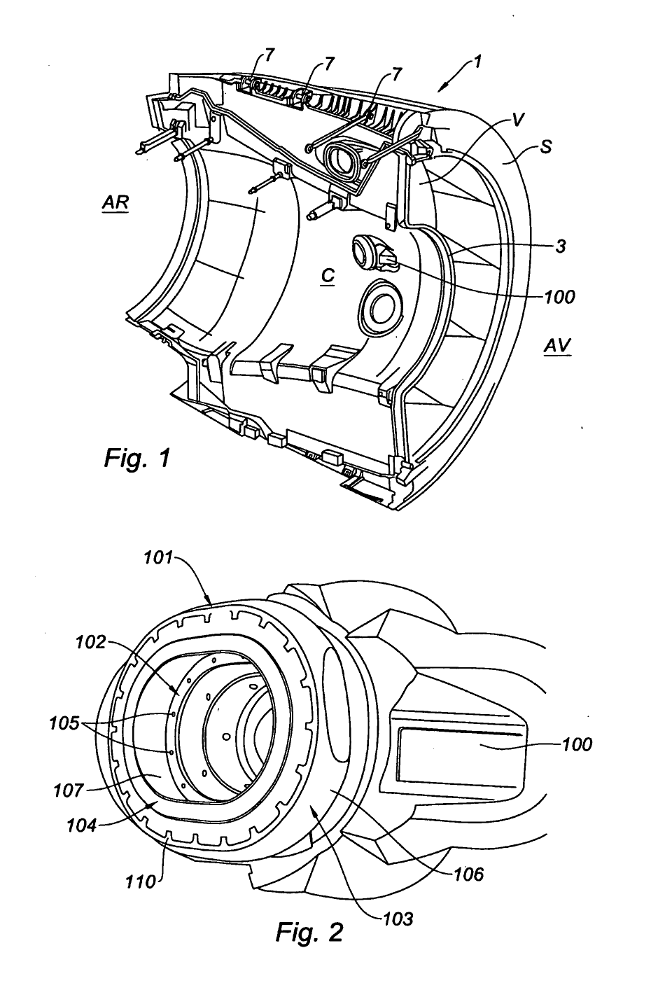

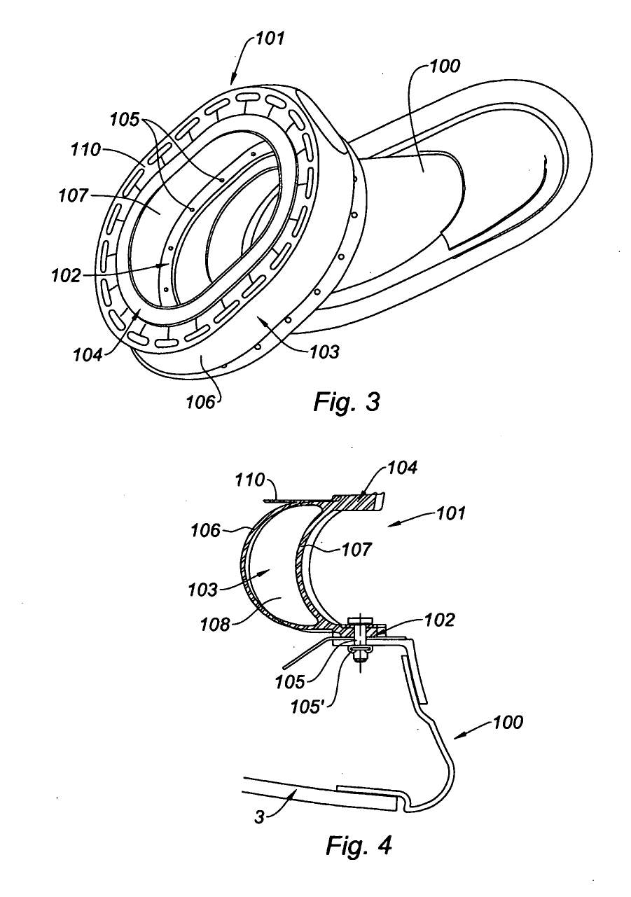

Reference is made to FIG. 1 which shows a nacelle right-hand half-shell 1 which in this instance is intended to be positioned at the rear of a nacelle and, with a second half-shell, constitutes a nacelle rear structure able to surround a rear part of a turbojet engine. It must be noted that this rear structure may incorporate thrust-reversal means, it being understood that the invention also applies to the case of a plain nacelle, that is to say one that has no thrust-reversal means.

The references AV and AR respectively denote the front and rear parts of the half-shell 1, with respect to the direction of the flow of air intended to flow within this half-shell 1.

In this particular instance, this half-shell 1 comprises an internal half-structure 3, defining a half-cavity C intended to accommodate a turbojet engine (not depicted).

This half-shell 1 also comprises an outer structure 5 defining, with the inner structure 3, a half-flow-path V intended to have passing through it a cold air flow that flows between the front and the rear of the half-shell 1.

In its upper part, that is to say in its part intended to be positioned toward the top when this half-shell 1 is mounted under the wing of an aircraft, this half-shell comprises several hinge points 7 designed to allow the half-shell 1 to be mounted on the pylon (or strut) of an aircraft wing (not depicted).

As explained previously, the turbojet engine incorporates a collection of cooling air circulation ducts bound for casing elements liable to experience radial and/or longitudinal deformations under the influence of the turbojet engine temperature.

This cooling air is bled from the flow path V of the cold flow by means of a scoop 100.

The scoop 100 therefore belongs to the half-shell C and has to channel the bled air to the cooling circuit mounted on the turbojet engine.

These two elements constitute distinct subassemblies liable to undergo radial and/or longitudinal relative movements.

Specifically, the expansion forces applied to the turbojet engine and to the half-shell C, which is subjected to the cold flow, are very different.

Because of these movements, the scoop 100 is connected to the cooling air distribution circuit by means of a seal 101 according to the invention.

The seal 101 comprises a mounting plate 102, a fluidtight flexible central part 103 and a bearing mating surface 104.

The mounting plate 102 is intended to allow the seal 101 to be fixed to the scoop 100. To do this, it has a substantially annular or oblong surface tailored to the shape of the scoop 100, said surface being pierced so that it has a plurality of holes each intended to accept a fixing means of the stud 105 type passing through each hole to enter a corresponding hole in the scoop 100 to which it is fixed by means of a complementary fixing means of the retaining ring 105′ type.

The flexible central part 103 constitutes the sealing part proper. It has a substantially cylindrical shape and is made of aramid- and glass-fiber-reinforced silicone. It is made up of an outer wall 106 and of an inner wall 107 which are peripheral and meet at the mounting surface 102 and at the mating surface 104, and together delimit an empty interior space 108.

The upper part of the seal 101 constitutes the mating surface 104 intended to come into mating contact with the second duct and comprising, according to the invention, a reinforcing plate 110.

For that, the central part 103 made of silicone has, in its upper part, an additional thickness molded over the reinforcing plate 110 so as to incorporate it into the seal 101.

This reinforcing plate 110 is a perforated stainless steel plate forming a peripheral ring. The apertures made in the plate make this added component lighter in weight.

When the seal 101 is subjected to compressive forces, the reinforcing plate 110 acts as a screen and prevents the compressed central part 103 from protruding onto the second duct.

Furthermore, the relative radial movements give rise to friction forces which are now borne by the reinforcing plate 110, which is stronger, rather than by the fragile silicone of the central part 103.

Of course the invention is not restricted to the embodiment described hereinabove by way of nonlimiting example but encompasses all embodiments thereof.

1. A seal intended to be fitted between a first duct and a second duct which are liable to undergo axial and/or radial relative movements but which both belong to a fluid distribution circuit, said seal comprising:
a flexible central part having a substantially cylindrical overall shape tailored to a shape of the first and second ducts and made from a material that is fluidtight in respect of the fluid concerned and having, on one side, a mounting surface intended to allow the seal to be fixed to the first duct, and, on another side, a mating surface intended to come into mating contact with the second duct in order to produce a fluidtight flexible connection between the first and second ducts,
wherein the mating surface comprises a peripheral reinforcement running radially at least partially over the central part.

2. The seal as claimed in claim 1, wherein the mounting surface is made from a fixing ring having holes intended to accept fixing means able to collaborate with corresponding bores in the first duct.

3. The seal as claimed in claim 1, wherein the fluidtight central part is made of silicone.

4. The seal as claimed in claim 1, wherein the fluidtight central part is made of glass and/or ceramic fiber.

5. The seal as claimed in claim 1, wherein the fluidtight central part is made of aramid fiber.

6. The seal as claimed in claim 1, wherein the fibers are woven.

7. The seal as claimed in claim 1, wherein the reinforcement is a plate made of stainless steel.

8. The seal as claimed in claim 1, wherein the reinforcement comprises a peripheral part built into a mass of the seal.

9. The seal as claimed in claim 1, wherein the reinforcement has a perforated surface.

10. The seal as claimed in claim 1, wherein the reinforcement has an external peripheral edge that is flanged or locally stiffened.

11. The seal as claimed in claim 1, wherein the central part comprises at least one external surface and at least one internal surface that are peripheral, delimiting at least one hollow interior space.

12. The seal as claimed in claim 1, wherein the reinforcement has a stiffened external peripheral part.
